(19) United States
(12) Patent Application Publication
(10) Pub. No.: US 2026/0162199 A1
(43) Pub. Date: Jun. 11, 2026

(54) Method and Medium for Quick Square Roof Reporting

(71) Applicant: Pictometry International Corp., Rochester, NY (US)

(72) Inventors: Chris T. Thornberry, Indianapolis, IN (US); Dale R. Thornberry, Carmel, IN (US)

(21) Appl. No.: 19/265,914

(22) Filed: Jul. 10, 2025

Related U.S. Application Data
(63) Continuation of application No. 18/959,190, filed on Nov. 25, 2024, now abandoned.
Application No. 18/959,190 is a continuation of application No. 18/735,527, filed on Jun. 6, 2024, now abandoned.
Application No. 18/735,527 is a continuation of application No. 18/415,187, filed on Jan. 17, 2024, now abandoned.
Application No. 18/415,187 is a continuation of application No. 18/449,882, filed on Aug. 15, 2023, now abandoned.
Application No. 18/449,882 is a continuation of application No. 18/189,804, filed on Mar. 24, 2023, now abandoned.
Application No. 18/189,804 is a continuation of application No. 18/049,820, filed on Oct. 26, 2022, now abandoned.
Application No. 18/049,820 is a continuation of application No. 17/844,490, filed on Jun. 20, 2022, now abandoned.
Application No. 17/844,490 is a continuation of application No. 16/503,094, filed on Jul. 3, 2019, now abandoned.
Application No. 16/503,094 is a continuation of application No. 14/934,882, filed on Nov. 6, 2015, now Pat. No. 10,346,935.
Application No. 14/934,882 is a continuation of application No. 13/424,054, filed on Mar. 19, 2012, now Pat. No. 9,183,538.

(51) Int. Cl. G06Q 50/16; G06Q 10/00; G06Q 10/10; G06Q 30/0601; G06Q 50/08; G06T 7/62

(52) U.S. Cl. CPC G06Q 50/16; G06Q 10/00; G06Q 10/10; G06Q 30/0631; G06Q 50/08; G06T 7/62; G06T 2207/30184

(57) ABSTRACT

Methods and systems for roof estimations, including a method comprising analyzing, with a computer processor, pixels of at least two images of the roof taken from different perspectives a roof having a plurality of roof portions, the at least two images taken from different perspectives, at least one of the images being an oblique image; determining, based on the analysis of the pixels, a footprint of the roof, comprising an outer boundary of the roof, utilizing two-dimensional or three-dimensional information regarding edges of the roof to determine line segments of the footprint; and a predominant pitch of the roof; determining an estimated roofing area of the roof based on the predominant pitch and the footprint of the roof; and generating a roof report, wherein the roof report includes at least one image showing the roof and the estimated roofing area of the roof.

### CROSS-REFERENCE TO RELATED APPLICATIONS

The present patent application is a continuation of the patent application filed Nov. 25, 2024, identified by Ser. No. 18/959,190, which is a continuation of the patent application filed Jun. 6, 2024, identified by Ser. No. 18/735,527 (now abandoned), which is a continuation of the patent application filed Jan. 17, 2024, identified by Ser. No. 18/415,187 (now abandoned), which is a continuation of the patent application filed Aug. 15, 2023, identified by Ser. No. 18/449,882 (now abandoned), which is a continuation of the application filed Mar. 24, 2023, identified by Ser. No. 18/189,804 (now abandoned), which is a continuation of the application filed Oct. 26, 2022, identified by Ser. No. 18/049,820 (now abandoned), which is a continuation of the application filed Jun. 20, 2022, identified by Ser. No. 17/844,490 (now abandoned); which is a continuation of the application filed Jul. 3, 2019, identified by Ser. No. 16/503,094 (now abandoned); which is a continuation of the patent application filed Nov. 6, 2015, identified by Ser. No. 14/934,882, which issued as U.S. Pat. No. 10,346,935; which is a continuation of the patent application, filed Mar. 19, 2012, identified by Ser. No. 13/424,054, publication number US 2013/0246204A1 , which issued as U.S. Pat. No. 9,183,538, entitled “Method and System for Quick Square Roof Reporting”; the entire contents of each of which are hereby incorporated by reference herein.

### BACKGROUND

Residential and/or commercial property owners approaching a major roofing project may be unsure of the amount of material needed and/or the next step in completing the project. Generally, such owners contact one or more contractors for a site visit. Each contractor must physically be present at the site of the structure in order to make a determination on material needs and/or time. The time and energy for providing such an estimate becomes laborious and may be affected by contractor timing, weather, contractor education, and the like. Estimates may be varied even between contractors in determination of estimated square footage causing variance in supply ordering as well. Additionally, measuring an actual roof may be costly and potentially hazardous - especially with steeply pitched roofs. Completion of a proposed roofing project may depend on ease in obtaining a simplified roofing estimate and/or obtaining reputable contractors for the roofing project.

Images are currently being used to measure objects and structures within the images, as well as to be able to determine geographic locations of points within the image when preparing estimates for a variety of construction projects, such as roadwork, concrete work, and roofing. Estimating construction projects using software may increase speed at which an estimate can be prepared, and may reduce labor and fuel costs associated with on-site visits.

### BRIEF DESCRIPTION OF THE SEVERAL VIEWS OF THE DRAWINGS

Like reference numerals in the figures represent and refer to the same or similar element or function. Implementations of the disclosure may be better understood when consideration is given to the following detailed description thereof. Such description makes reference to the annexed pictorial illustrations, schematics, graphs, drawings, and appendices. In the drawings:

FIG. 1 is a schematic diagram of an embodiment of a roof estimator reporting system according to the instant disclosure.

FIG. 2 is a block diagram of an embodiment of one or more memory according to the instant disclosure.

FIG. 3 is an exemplary embodiment of a program logic according to the instant disclosure.

FIG. 4 is another exemplary embodiment of a program logic according to the instant disclosure.

FIG. 5 is yet another exemplary embodiment of a program logic according to the instant disclosure.

FIG. 6 is a further exemplary embodiment of a program logic according to the instant disclosure.

FIG. 7 is an exemplary slope factor chart for determining pitch factors according to the instant disclosure.

FIG. 8A is an exemplary embodiment of a roofing report presentation page according to the instant disclosure.

FIG. 8B another exemplary embodiment of a roofing report presentation page according to the instant disclosure.

### DETAILED DESCRIPTION OF INVENTIVE CONCEPT

Before explaining at least one embodiment of the inventive concept disclosed herein in detail, it is to be understood that the inventive concept is not limited in its application to the details of construction and the arrangement of the components or steps or methodologies set forth in the following description or illustrated in the drawings. The inventive concept disclosed herein is capable of other embodiments or of being practiced or carried out in various ways. Also, it is to be understood that the phraseology and terminology employed herein is for the purpose of description and should not be regarded as limiting in any way.

In the following detailed description of embodiments of the inventive concept, numerous specific details are set forth in order to provide a more thorough understanding of the inventive concept. It will be apparent to one of ordinary skill in the art, however, that the inventive concept within the disclosure may be practiced without these specific details. In other instances, well-known features have not been described in detail to avoid unnecessarily complicating the instant disclosure.

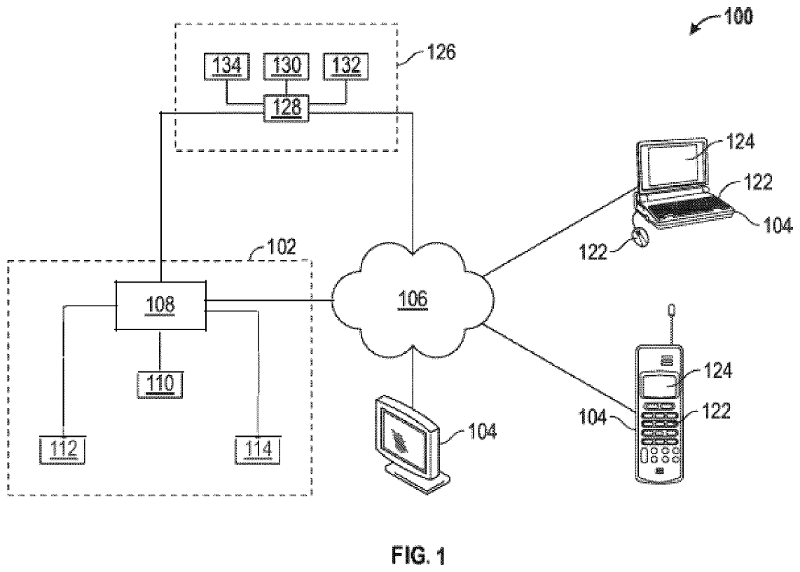

Referring now to the drawings, and in particular to FIG. 1, shown therein and designated by a reference numeral 100 is an exemplary computer system 100 constructed in accordance with the present disclosure. The system 100 can be a system or systems that are able to embody and/or execute the logic of the processes described herein. The logic embodied in the form of software instructions, or firmware may be executed on any appropriate hardware which may be a dedicated system or systems.

As used herein, the terms “network-based”, “cloud-based” and any variations thereof, are intended to include the provision of configurable computational resources on demand via interfacing with a computer and/or computer network, with software and/or data at least partially located on the computer and/or computer network, by pooling processing power of two or more networked processors.

As used herein, the terms “comprises”, “comprising”, “includes”, “including”, “has”, “having”, or any other variation thereof, are intended to be non-exclusive inclusions. For example, a process, method, article, or apparatus that comprises a set of elements is not limited to only those elements but may include other elements not expressly listed or even inherent to such process, method, article, or apparatus.

As used in the instant disclosure, the terms “provide”, “providing”, and variations thereof comprise displaying or providing for display a webpage (e.g., roofing webpage) to one or more user terminals interfacing with a computer and/or computer network(s) and/or allowing the one or more user terminal(s) to participate, such as by interacting with one or more mechanisms on a webpage (e.g., roofing webpage) by sending and/or receiving signals (e.g., digital, optical, and/or the like) via a computer network interface (e.g., Ethernet port, TCP/IP port, optical port, cable modem, and combinations thereof). A user may be provided with a web page in a web browser, or in a software application, for example.

As used herein, the term “roof request”, “roofing request”, “roofing order”, and any variations thereof may comprise a feature of the graphical user interface or a feature of a software application, allowing a user to indicate to a host system that the user wishes to place an order, such as by interfacing with the host system over a computer network and exchanging signals (e.g., digital, optical, and/or the like), with the host system using a network protocol, for example. Such mechanism may be implemented with computer executable code executed by one or more processors, for example, with a button, a hyperlink, an icon, a clickable symbol, and/or combinations thereof, that may be activated by a user terminal interfacing with the at least one processor over a computer network, for example.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, the use of the “a” or “an” are employed to describe elements and components of the embodiments herein. This is done merely for convenience and to give a general sense of the inventive concept. This description should be read to include one or more, and the singular also includes the plural unless it is obvious that it is meant otherwise.

Finally, as used herein any reference to “one embodiment” or “an embodiment” means that a particular element, feature, structure, or characteristic described in connection with the embodiment is included in at least one embodiment. The appearance of the phrase “in one embodiment” in various places in the specification are not necessarily all referring to the same embodiment.

Referring now to FIG. 1, shown therein is an exemplary embodiment of a roof estimator reporting system 100 according to the instant disclosure. The system 100 comprises two or more host systems 102 and 126 interfacing and/or communicating with one or more user terminals 104 via a network 106.

The one or more user terminals 104 may be implemented as a personal computer, a smart phone, network-capable TV set, TV set-top box, a tablet, an e-book reader, a laptop computer, a desktop computer, a network-capable handheld device, a video game console, a server, a digital video recorder, a DVD-player, a Blu-Ray player and combinations thereof, for example. In an exemplary embodiment, the user terminal 104 may comprise an input device 122, an output device 124, a processor (not shown) capable of interfacing with the network 106, processor executable code (not shown), and a web browser capable of accessing a website and/or communicating information and/or data over a network, such as the network 106. As will be understood by persons of ordinary skill in the art, the one or more user terminals 104 may comprise one or more non-transient memories comprising processor executable code and/or software applications, for example.

The input device 122 may be capable of receiving information input from a user and/or other processor(s), and transmitting such information to the user terminal 104 and/or to the host system 102. The input device 122 may be implemented as a keyboard, a touchscreen, a mouse, a trackball, a microphone, a fingerprint reader, an infrared port, a slide-out keyboard, a flip-out keyboard, a cell phone, a PDA, a video game controller, a remote control, a fax machine, a network interface, and combinations thereof, for example.

The output device 124 may output information in a form perceivable by a user and/or other processor(s). For example, the output device 124 may be a server, a computer monitor, a screen, a touchscreen, a speaker, a website, a TV set, a smart phone, a PDA, a cell phone, a fax machine, a printer, a laptop computer, and combinations thereof. It is to be understood that in some exemplary embodiments, the input device 122 and the output device 124 may be implemented as a single device, such as, for example, a touchscreen or a tablet. It is to be further understood that as used herein the term user is not limited to a human being, and may comprise a computer, a server, a website, a processor, a network interface, a human, a user terminal, a virtual computer, and combinations thereof, for example.

The system 100 may include one or more host systems. For example, FIG. 1 illustrates system 100 having two host systems 102 and 126. The host systems 102 and 126 may be partially or completely network-based or cloud based, and not necessarily located in a single physical location. Each of the host systems 102 and 126 may further be capable of interfacing and/or communicating with the one or more user terminals 104 via the network 106, such as by exchanging signals (e.g., digital, optical, and/or the like) via one or more ports (e.g., physical or virtual) using a network protocol, for example. Additionally, each host system 102 and 126 may be capable of interfacing and/or communicating with other host systems directly and/or via the network 106, such as by exchanging signals (e.g., digital, optical, and/or the like) via one or more ports.

In some embodiments, host systems 102 and 126 may be independently controlled by separate entities. Host system 102 may be controlled by a first company and host system 126 may be controlled by a second company distinct from the first company. For example, host system 102 may be controlled by a roofing material supplier and host system 126 may be controlled by a roofing report company. The roofing material supplier may be a separate entity from the roofing report company.

The host system 102 may be referred to hereinafter as the “first host system” and the host system 126 may be referred to hereinafter as the “second host system”. The first host system 102 may comprise one or more processors 108 working together, or independently to, execute processor executable code, one or more memories 110 capable of storing processor executable code, one or more input devices 112, and one or more output devices 114. Each element of the first host system 102 may be partially or completely network-based or cloud-based, and not necessarily located in a single physical location.

The one or more processors 108 may be implemented as a single or plurality of processors 108 working together, or independently to execute the logic as described herein. Exemplary embodiments of the one or more processors 108 include a digital signal processor (DSP), a central processing unit (CPU), a field programmable gate array (FPGA), a microprocessor, a multi-core processor, and/or combinations thereof. The one or more processors 108 may be capable of communicating with the one or more memories 110 via a path (e.g., data bus). The one or more processors 108 may be capable of communicating with the input devices 112 and the output devices 114.

The one or more processors 108 may be further capable of interfacing and/or communicating with the one or more user terminals 104 via the network 106. For example, the one or more processors 108 may be capable of communicating via the network 106 by exchanging signals (e.g., digital, optical, and/or the like) via one or more physical or virtual ports using a network protocol. It is to be understood that in certain embodiments using more than one processor 108, the one or more processors 108 may be located remotely from one another, located in the same location, or comprising a unitary multi-core processor (not shown). The one or more processors 108 may be capable of reading and/or executing processor executable code and/or of creating, manipulating, altering, and/or storing computer data structures into one or more memories 110.

The one or more memories 110 may be capable of storing processor executable code. Additionally, the one or more memories 110 may be implemented as a conventional non-transient memory 110, such as, for example, random access memory (RAM), a CD-ROM, a hard drive, a solid state drive, a flash drive, a memory card, a DVD-ROM, a floppy disk, an optical drive, and/or combinations thereof. It is to be understood that while one or more memories 110 may be located in the same physical location as the first host system 102, the one or more memories 110 may be located remotely from the first host system 102, and may communicate with the one or more processor 108 via the network 106. Additionally, when more than one memory 110 is used, a first memory 110 may be located in the same physical location as the first host system 102, and additional memories 110 may be located in a remote physical location from the first host system 102. The physical location(s) of the one or more memories 110 may be varied. Additionally, one or more memories 110 may be implemented as a “cloud memory” (i.e., one or more memory 110 may be partially or completely based on or accessed using the network 106).

The one or more input devices 112 may transmit data to the processors 108, and may be implemented as a keyboard, a mouse, a touchscreen, a camera, a cellular phone, a tablet, a smart phone, a PDA, a microphone, a network adapter, and/or combinations thereof. The input devices 112 may be located in the same physical location as the first host system 102, or may be remotely located and/or partially or completely network-based.

The one or more output devices 114 may transmit information from the processor 108 to a user, such that the information may be perceived by the user. For example, the output devices 114 may be implemented as a server, a computer monitor, a cell phone, a tablet, a speaker, a website, a PDA, a fax, a printer, a projector, a laptop monitor, and/or combinations thereof. The output device 114 may be physically co-located with the first host system 102, or may be located remotely from the first host system 102, and may be partially or completely network based (e.g., website). As used herein, the term “user” is not limited to a human, and may comprise a human, a computer, a host system, a smart phone, a tablet, and/or combinations thereof, for example.

The first host system 102 may directly communicate with the second host system 126 and/or communicate via network 106. Generally, the first host system 102 may include one or more processors 108 capable of executing a first set of processor executable code and the second host system 126 may include one or more processors 128 capable of executing a second set of processor executable code.

The second host system 126 may further comprise one or more memories 130 capable of storing processor executable code, one or more input devices 132, and one or more output devices 134. Each element of the second host system 126 may be partially or completely network-based or cloud based, and not necessarily located in a single physical location.

The one or more processors 128 may be implemented as a single or a plurality of processors 128 working together to execute the logic described herein. Exemplary embodiments of the one or more processors 128 include a digital signal processor (DSP), a central processing unit (CPU), a field programmable gate array (FPGA), a microprocessor, a multi-core processor, and/or combinations thereof. The one or more processors 128 may be capable of communicating with the one or more memories 130 via a path (e.g., data bus). The one or more processors 128 may be capable of communicating with the input devices 132 and the output devices 134.

The one or more processors 128 may be further capable of interfacing and/or communicating with the one or more user terminals 104 via the network 106. For example, the one or more processors 128 may be capable of communicating via the network 106 by exchanging signals (e.g., digital, optical, and/or the like) via one or more physical or virtual ports using a network protocol. It is to be understood that in certain embodiments using more than one processor 128, the one or more processors 128 may be located remotely from one another, located in the same location, or comprising a unitary multi-core processor (not shown). The one or more processors 128 may be capable of reading and/or executing processor executable code and/or of creating, manipulating, altering, and/or storing computer data structures into one or more memories 130.

The one or more memories 130 may be capable of storing processor executable code. Additionally, the one or more memories 130 may be implemented as a conventional non-transient memory 130, such as, for example, random access memory (RAM), a CD-ROM, a hard drive, a solid state drive, a flash drive, a memory card, a DVD-ROM, a floppy disk, an optical drive, and/or combinations thereof. It is to be understood that while one or more memories 130 may be located in the same physical location as the second host system 126, the one or more memories 130 may be located remotely from the second host system 126, and may communicate with the one or more processor 128 via the network 106. Additionally, when more than one memory 130 is used, a first memory 130 may be located in the same physical location as the second host system 126, and additional memories 130 may be located in a remote physical location from the second host system 126. The physical location(s) of the one or more memories 130 may be varied. Additionally, one or more memories 130 may be implemented as a “cloud memory” (i.e., one or more memory 130 may be partially or completely based on or accessed using the network 106).

The input devices 132 may transmit data to the processors 128, and may be implemented as a keyboard, a mouse, a touchscreen, a camera, a cellular phone, a tablet, a smart phone, a PDA, a microphone, a network adapter, and/or combinations thereof. The input devices 132 may be located in the same physical location as the second host system 126, or may be remotely located and/or partially or completely network-based.

The output devices 134 may transmit information from the processors 128 to a user, such that the information may be perceived by the user. For example, the output devices 134 may be implemented as a server, a computer monitor, a cell phone, a tablet, a speaker, a website, a PDA, a fax, a printer, a projector, a laptop monitor, and/or combinations thereof. The output devices 134 may be physically co-located with the second host system 126, or may be located remotely from the second host system 126, and may be partially or completely network based (e.g., website).

The network 106 may permit bi-directional communication of information and/or data between the first host system 102, the second host system 126 and/or user terminals 104. The network 106 may interface with the first host system 102, the second host system 126, and the user terminals 104 in a variety of ways. For example, the network 106 may interface by optical and/or electronic interfaces, and/or may use a plurality of network topographies and/or protocols including, but not limited to, Ethernet, TCP/IP, circuit switched paths, and/or combinations thereof. For example, the network 106 may be implemented as the World Wide Web (or Internet), a local area network (LAN), a wide area network (WAN), a metropolitan network, a wireless network, a cellular network, a GSM-network, a CDMA network, a 3G network, a 4G network, a satellite network, a radio network, an optical network, a cable network, a public switched telephone network, an Ethernet network, and/or combinations thereof. Additionally, the network 106 may use a variety of network protocols to permit bi-directional interface and/or communication of data and/or information between the first host system 102, the second host system 126, and/or one or more user terminals 104.

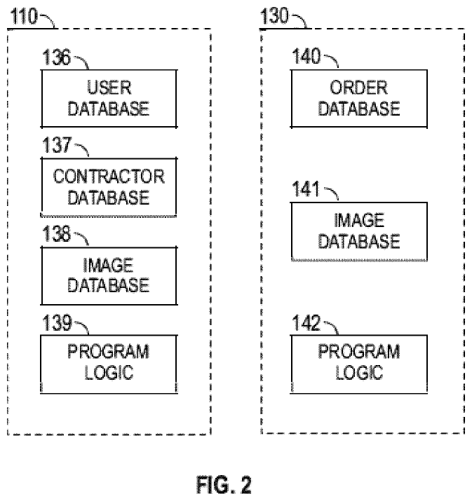

Referring to FIGS. 1 and 2, the one or more memories 110 may store processor executable code and/or information comprising a user database 136, a contractor database 137, a first image database 138 and program logic 139. The processor executable code may be stored as a data structure, such as a database and/or a data table, for example.

The user database 136 may include information about customers engaging with the first host system 102. For example, one or more customers may access the first host system 102 through the one or more user terminals 104. The first host system 102 may provide a roof request website to the user terminal 104. The roof request website may be directed by the one or more processors 108. The processor 108 may also direct the one or more customers to a login/registration portion of the website.

In some embodiments, customers may register a user profile with the first host system 102. The user profile may be created and/or stored in the user database 136 by the processor 108. For example, the customer may be prompted by the processor 108 to provide login credentials (e.g., username and/or password). Login credentials may allow the processor 108 to authenticate the customer against the user database 136. In this manner, the first host system 102 may access the user profile in the user database 136. The user profile may include information including, but not limited to, demographic information including, but not limited to, name, age, address, billing account information, username, password, behavioral information, experience, gender, and/or the like.

If user authentication is successful, the user profile may be accessed by the processor 108. If the user authentication fails, the customer may be returned to the login/registration page, where the customer may be prompted for a username and password again. Optionally, the processor 108 may block a customer from entering a username and/or password after a preset number of failed authentication attempts.

In some embodiments, customers may be prompted by the processor 108 to provide information for a user profile without registration and/or authentication using a username and/or password. The user profile may be created and/or stored in the user database 136 by the processor 108. For example, the processor 108 may prompt the customer to provide demographic information (e.g., name, address, billing account information, and the like), and store the information in a user profile for the customer using a unique customer identification.

The contractor database 137 may comprise information about roofing contractors within a given geographic location. Each roofing contractor may be associated with a contractor profile having information including, but not limited to, roofing contractor business name, roofing contractor owner name, address, experience level, age of contractor business, review information, and the like. In some embodiments, the contractor profile may include a geographical category assignment identification (ID). For example, the contractor profile may be assigned a numerical or alphabetical identification based on geographic location of the business.

In some embodiments, the contractor profile may include review information. The review information may include positive and/or negative feedback relating to each contractor. For example, the review information may be based on prior customer feedback of customers using the system 100. Review information may also be obtained from one or more outside databases (e.g., Yelp, Google review, and/or the like).

One or more contractors may provide a contractor profile via the first host system 102. For example, one or more contractors may access the roof review website of the first host system 102 via the user terminal 104. The processor 108 may direct the contractor via the roof review website to a login/registration portion of the website. If the contractor has previously registered with the first host system 102, the contractor may be prompted by the processor 108 to provide login credentials (e.g., username and/or password), which may allow the processor 108 to authenticate the contractor against the contractor database 137.

If the contractor is not registered with the first host system 102, the first host system 102 may prompt the contractor to provide information via the one or more user terminals 104 to create a contractor profile. Alternatively, the contractor profiles may be provided in the contractor database 137 without information provided by each contractor. For example, a user of the first host system 102 may provide information via the input device 112, the network 106, and/or the like, setting up a contractor profile without direct knowledge of the contractor.

The one or more memories 110 may include the image database 138. The image database 138 may store geo-referenced imagery. Such imagery may be represented by a single pixel map, and/or by a series of tiled pixel maps that when aggregated recreate the image pixel map. Imagery may include nadir, ortho-rectified and/or oblique geo-referenced images. The one or more processors 108 may provide the images via the image database 138 to customers at the one or more user terminals 104. Customers, using the user terminals 104, may provide geographic location information associated with a roof request using the geo-referenced images provided by the one or more processors 108. For example, a customer may be provided a geo-referenced image to validate the location of a structure (e.g., roof). In some embodiments, the customer may be able to select the structure (e.g., via a drag-and-drop user interface) to pinpoint a location of the structure within the image. Selection of the structure may provide location information (e.g., latitude/longitude coordinate, or and the like) of the structure to the first host system 102. For simplicity, the description will provide for a roof as the structure of interest. However, is should be apparent that other structures of buildings and/or landscapes may be used in accordance with the present disclosure.

The one or more memories 110 may further store processor executable code and/or instructions, which may comprise the program logic 139. The program logic 139 may comprise processor executable instructions and/or code, which when executed by the processor 108, may cause the processor 108 to generate, maintain, provide, and/or host a website providing one or more roofing requests, for example. The program logic 139 may further cause the processor 108 to collect user information and/or contractor information, create user profiles and/or contractor profiles, provide users one or more geo-referenced images, and allow one or more users to validate a location of the roof as described herein.

The one or more processors 108 may generate, maintain, or provide one or more roofing orders to the second host system 126. For example, the one or more processors 108 may provide the one or more roofing orders to the second host system 126 by copying information obtained and/or stored in one or more memories 110. The roofing orders may include contractor profile, user profile, user validated images, a unique ordering ID, and/or the like.

The one or more memories 130 of the second host system 126 may store processor executable code and/or information comprising an order database 140, a second image database 141 and the program logic 142. The processor executable code may be stored as a data structure, such as a database and/or a data table, for example.

The order database 140 may include information about a roofing order placed by a customer and copied by the first host system 102. For example, a roofing order may include contractor profile, user profile, user validated images, a unique ordering ID, and/or the like. The second host system 126 may access the order database 140 to provide a roofing report as described in detail herein.

The one or more memories 130 of the second host system 126 may also include a second image database 141. The second image database 141 may provide additional nadir, ortho-rectified, and/or oblique geo-referenced and/or non-geo-referenced images for use in providing a roofing report as described in detail herein. Alternatively, the image database 138 and the image database 141 may be the same database.

The one or more memories 130 of the second host system 126 may further store processor executable code and/or instructions, which may comprise program logic 142. The program logic 142 may comprise processor executable instructions and/or code, which when executed by the one or more processors 128, may cause the one or more processors 128 to generate, maintain, and/or provide a website or series of websites for providing roofing reports. The program logic 142 may further cause the one or more processors 128 to allow one or more users to participate in executing a roofing report via the input devices 132.

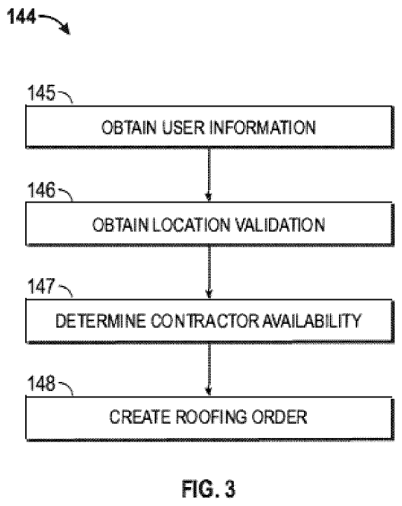

Referring to FIG. 3, shown therein is an exemplary flow chart 144 of program logic 139 for creating a roof report order which may be used with the first host system 102 according to the instant disclosure. Program logic 139 may comprise executable code, which when executed by the one or more processors 108 may cause the one or more processors 108 to execute one or more of the following:

The program logic 139 may provide for one or more user terminals 104 interfacing with the processor 108 over the network 106 to provide one or more roofing request website pages allowing customers to place a roofing request order. Each order is generally a request of the customer to provide estimated square footage of a specific roof. Additionally, each order may also include a request for contractor information and/or a bid request for estimate costs and associated features of materials, supplies, physical labor, and the like.

Generally, in a step 145, customers using one or more user terminals 104 may provide user information to the first host system 102. The user information may then be used to prepare one or more user profiles for use in preparing the roofing report. Additionally, program logic 139 may generate a unique identification number and/or alpha numeric character to associate with the user profile.

The user information may include a location of the roof provided by the customer. For example, the customer may provide a residential and/or commercial address of the roof. One or more processors 108 may direct customers to validate the location of the roof using user terminals 104, in step 146. For example, processors 108 may provide one or more images via the image database 138. The images may be geo-referenced images illustrating portions or all of the roof. The program logic 139 may cause the processor 108 to provide users the one or more geo-referenced images, and allow the customer to validate the location of the roof. For example, the customer may be able to use a drag-and-drop element provided by the program logic 139 via user terminal 104 to select the roof within the one or more geo-referenced images. Selection of the roof within the one or more geo-referenced images may provide one or more validated images and a validated location of the roof. In some embodiments, the geographic location may include coordinates, and validation of the geographic location may be provided by a customer by altering one or more coordinates of the geographic location. Customers may alter the one or more coordinates by methods including, but not limited to, manual manipulation, drag-and-drop elements, and the like.

It should be understood that validation of the geo-referenced images may be provided by the second host system 126 via the one or more processors 128 in lieu of, or in combination with host system 102. For example, the first host system 102 may direct customers to the second host system 126 wherein the one or more processors 128 of the second host system 126 provide geo-referenced images from image database 141 to the customer for validation of one or more roof and/or roofing structures. As such, in some embodiments, only the second host system 126 provides geo-referenced images in the image database 141.

The first host system 102 may determine contractor availability within a region of interest about the validated location of the roof as shown in step 147. For example, program logic 139 may extract the validated location and compare the validated location against location of contractors in a region of interest. The region of interest may be determined by the customer via user terminal and/or the region of interest may be a pre-programmed determination. For example, the region of interest may be a five mile radius about the validated location. Contractor availability may include contractors having a contractor profile within the contractor database 137. Contractors within the contractor database 137 may be provided with a copy of the roofing report as described herein.

The program logic 139 may direct the one or more processors 108 to create and/or store a roofing order for the customer as shown in step 148. Additionally, the program logic 139 may direct one or more processors to transfer the roofing order to the second host system 126.

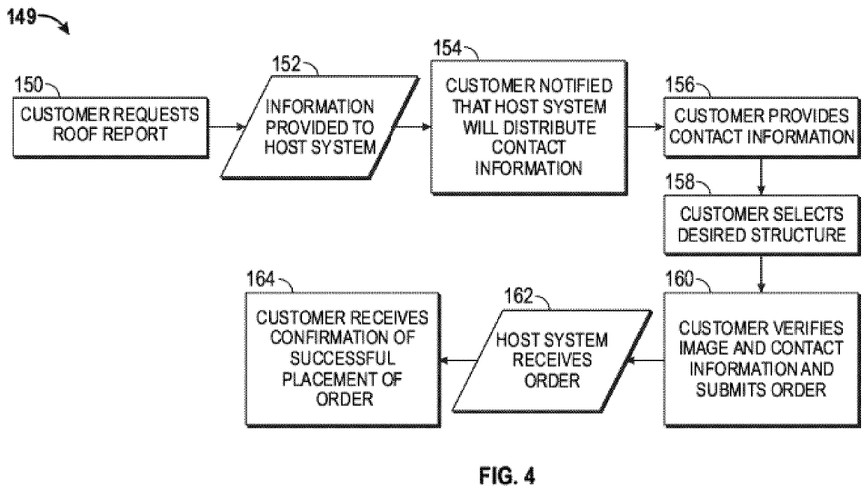

FIG. 4 illustrates a flow chart 149 of an exemplary embodiment of the program logic 139 and/or 142 for processing a roof report order which may be used with the system 100 according to the instant disclosure. The program logic 139 comprises processor executable code, that when executed by the processor 108, may cause the processor 108 to execute one or more of the following:

The program logic 139 may include a step 150 wherein one or more user terminals 104 interfacing with the processor 108 over the network 106 may be provided with one or more websites having a mechanism allowing a customer to request a roof report. The customer may provide the request to the first host system 102 using the one or more websites, in a step 152. Prior to providing customer information, the customer may be notified that the first host system 102 may distribute any contact information provided by the customer to contractors provided within the first host system 102. The one or more processors 108 may provide the customer an option for agreeing to terms of service (e.g., distribution of their contact information), in a step 154.

In a step 156, the roof report request website may include queries regarding customer information including, but not limited to, customer name, address, address of the roof, billing information, and the like. The customer information may be provided by the one or more processors 108 and stored in the one or more memories 110. For example, the customer information may be provided by processors 108 as a user profile and stored in the user database 136 of the one or more memories 110.

Customers may be able to select the desired roof, location, and/or the like on the one or more websites provided by the processor 108 over the network 106, in step 158. For example, the customer may use the one or more user terminals 104 to provide a geographical location (e.g., address, latitude/longitude coordinates, or the like), a geo-referenced image, and/or an element within a geo-referenced image. Once the geographical location of the roof is selected, the processor 108 may provide a verification web page or similar mechanism for customer review and/or approval of a proposed order, in a step 160. The first host system 102 may receive the proposed order via the processor 108, store the order and/or transfer the order to the second host system 126 for processing, in a step 162. The processor 108 may provide a confirmation webpage or similar mechanism informing the customer of a successful order placement, in a step 164.

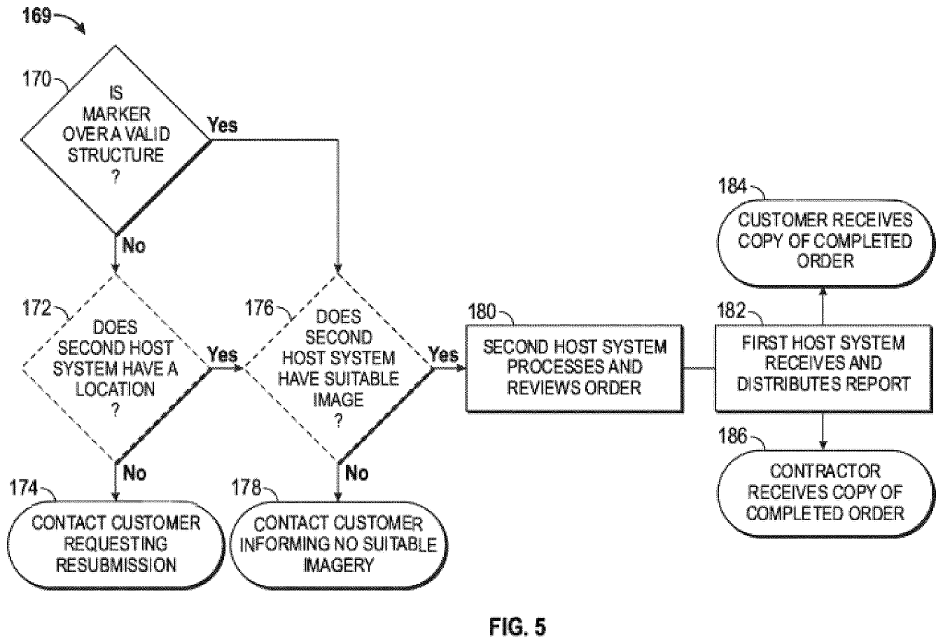

FIG. 5 illustrates a flow chart 169 of an exemplary embodiment of the program logic 139 and/or 142 for providing a roof report which may be used with the system 100 according to the instant disclosure. Generally, processing of the proposed order may be provided using the second host system 126. The program logic 142 comprises processor executable code, that when executed by the processor 128, may cause the processor 128 to execute one or more of the following:

The second host system 126 may receive the proposed order via the one or more processors 108 of the first host system 102. Generally, the validity of the location of the roof provided by the customer may be determined, in a step 170. In a step 172, the second host system 126 may determine if the location of the roof provided by the customer exists. If the location is not found, the customer may be further contacted by the second host system 126 and/or the first host system 102 requesting resubmission or additional information for the proposed order, in a step 174. Additionally, in a step 176, the second host system 126 may determine if corresponding imagery within image database 141 exists for the location provided by the customer. If there is no corresponding imagery, the customer may be further contacted by the second host system 126 and/or the first host system 102 with a status message indicating no suitable imagery of the roof currently exists, in a step 178.

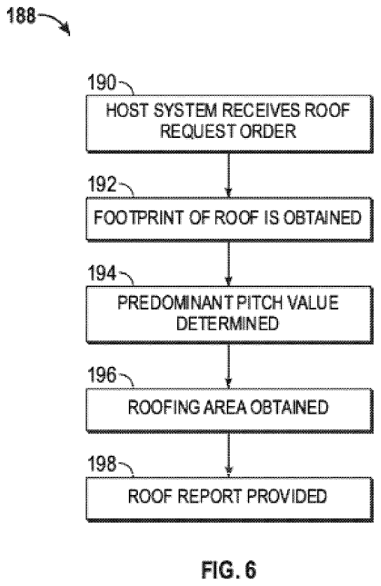

The second host system 126 may further process and review the order, in a step 180. An exemplary series of steps for implementing step 180 is shown in a flow chart 188 illustrated in FIG. 6. For example, the one or more processors 128 of the second host system 126 may receive the proposed order, in a step 190. The one or more processors 128 may extract order related information and images. Generally, a user may access a roof report website provided by the one or more processors 128 to review and/or process the proposed order. For example, the user may access the roof report website using the input devices 132 and the output devices 134 to review and/or process the proposed order.

In some embodiments, using the input devices 132 and/or the output devices 134, the user may provide additional details to the proposed order regarding the roof including, but not limited to, identification of areas of the roof (e.g., eaves, drip edges, ridges, and the like), pitch, distance, angle, and/or the like.

The footprint of the roof may be determined, in step 192. For example, the footprint of the roof may be determined using systems and methods including, but not limited to, those described in U.S. Patent Publication No. 2010/0179787, U.S. Patent Publication No. 2010/0110074, U.S. Patent Publication No. 2010/0114537, U.S. Patent Publication No. 2011/0187713, U.S. Pat. No. 8,078,436, and U.S. Ser. No. 12/090,692, all of which are incorporated by reference herein in their entirety.

In some embodiments, the one or more processors 128 may provide one or more websites to the user for evaluation of multiple oblique images to provide the footprint of the roof. For example, the user and/or the processors 128 may identify edges of the roof. Two-dimensional and/or three-dimensional information regarding the edges (e.g., position, orientation, and/or length) may be obtained from the images. Using the two-dimensional and/or three-dimensional information (e.g., position orientation, and/or length), line segments may be determined with multiple line segments forming at least a portion of the footprint of the roof.

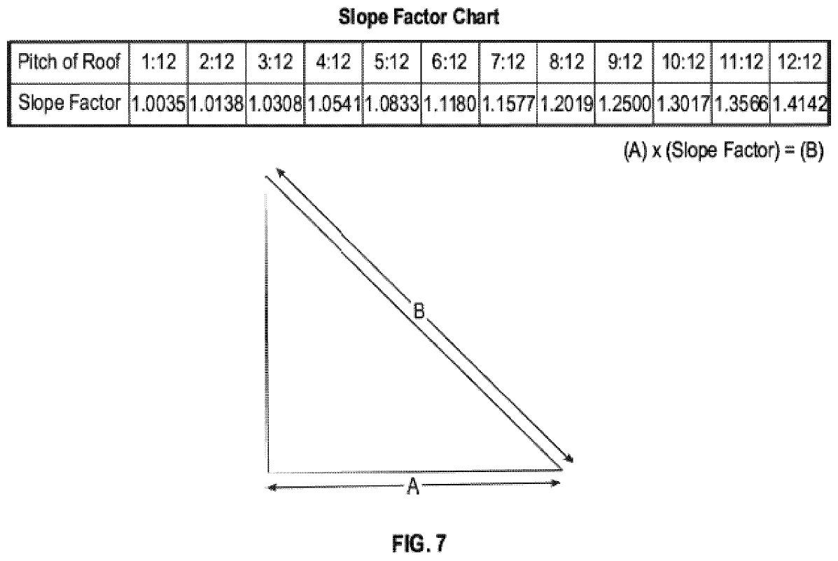

The footprint may provide a two-dimensional boundary and/or outline of the roof. In a step 194, a predominant pitch value for the roof may be determined. In some embodiments, a predominant pitch value may be determined using the footprint as a boundary of the roof. The predominant pitch may be a weighted average of individual pitch factors for two or more portions of the roof. FIG. 7 illustrates an exemplary slope factor chart for determining pitch factors. For example, a first portion of the roof (e.g., 60% of the roof) may be at a 6:12 pitch. The 6:12 pitch corresponds to 1.1180 as the pitch factor). A second portion of the roof (e.g. 40% of the roof) may be at a 4:12 pitch. The 4:12 pitch corresponds to 1.0541 as the pitch factor. Thus, the weighted value of the first portion of the roof having 6:12 pitch is:

(Pitch Factor)*(Percentage of roof)=First Weighted Value EQ. 1

1.1180*0.6=0.6708

The weighted value of the second portion of the roof having 4:12 pitch is:

(Pitch Factor)*(Percentage of roof)=Second Weighted Value EQ. 2

1.0541*0.4=0.42164

The sum of 0.6708 and 0.42164 is 1.09244 as the total weighted pitch value. A total weighted pitch value of 1.09244 is closest to a pitch factor of 1.0833 in the table in FIG. 7. This pitch factor corresponds to a 5:12 pitch. As such, the predominant pitch in this scenario would be 5:12. Using the predominant pitch and outer dimensions provided by the footprint, an estimated area of the roof may be determined, in a step 196.

In some embodiments, the user may review and reevaluate the estimated area of the roof obtained. For example, using the system and methods described herein, the user may review the steps for obtaining the footprint, the predominant pitch value, and/or estimated area. Additionally, the user may provide for a review report. The review report may comprise feedback to the one or more processors 128 regarding errors, concerns, and/or the like.

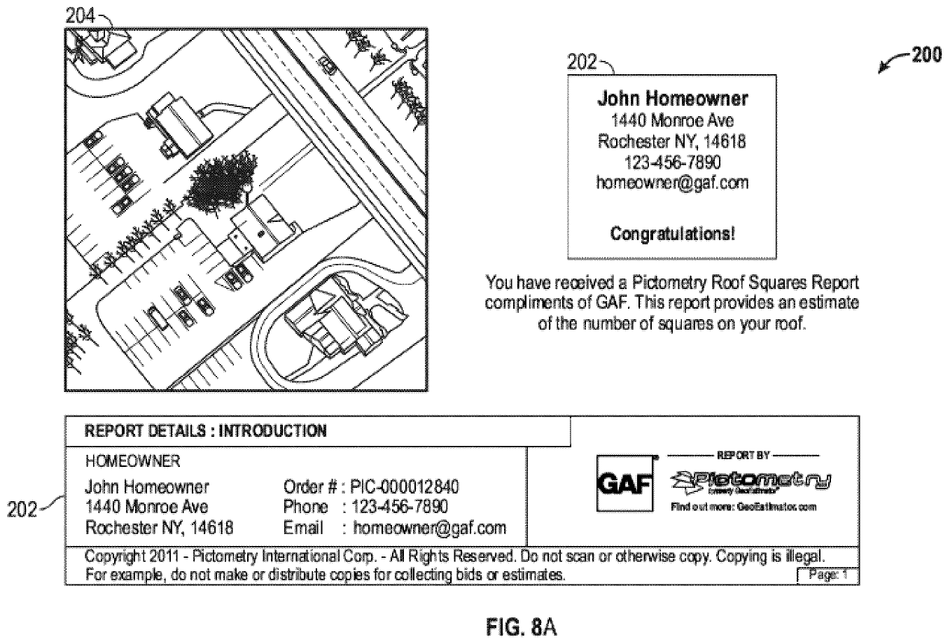

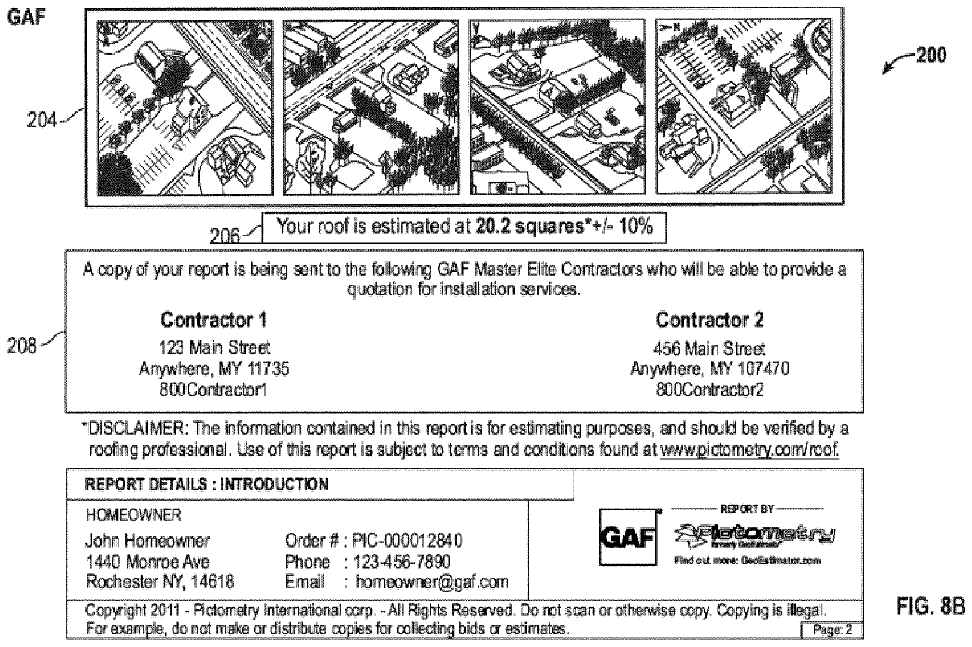

Referring to FIGS. 1, 6 and 8A-8B, in a step 184 and 186, a customer and/or contractor may receive a roof report 200. FIGS. 8A-8B illustrate an exemplary embodiment of a roof report 200 provided in accordance with the present disclosure. The program logic 139 may provide for one or more user terminals 104 interfacing with the processor 108 over the network 106 to provide one or more roofing report website pages allowing customers and/or contractors to view the roof report 200.

Generally, roofing reports within the industry are detailed with data sets regarding pitch, total area, eave length, hip ridge length, valley length, number of box vents, and the like. The roof report 200 may be streamlined to generally include data sets such as customer information 202, roofing 204, estimated area detail 206, and contractor(s) 208. The customer information data set 202 may include the customer name, customer contact information, and the like. The roofing data set 204 may include one or more nadir images of the roof and one or more oblique images of the roof. The estimated area detail 206 may provide the total estimated roof area as determined using the second host system 126 described herein. The contractor data set 208 may include one or more contractor names and associated contractor contact information for the one or more contractor names.

The roof report 200 may be distributed using the first host system 102 and/or the second host system 126 to the one or more user terminals 104. For example, the roof report 200 may be distributed using the first host system 102 to a contractor at a first user terminal 104 and the roof report 200 may be distributed using the first host system 102 to the customer at a second user terminal 104.

In some embodiments, the first host system 102 and/or the second host system 126 may distribute the roof report 200 to one or more recipients in addition to, or in lieu of, the customer. For example, the roof report 200 may be distributed to recipients including, but not limited to, roof material suppliers (e.g., small roofing companies, Lowes, Home Depot, and the like), insurance companies, real estate agencies, home services and/or cleaning companies, insulation companies, auditing companies, and/or contractors. Contractors and/or suppliers may be associated with residential and/or commercial building elements and/or services including, but not limited to, fireplaces, pool sales, fencing, lawn maintenance, gardening, pavement resurfacing, decking, sunrooms, roofing, guttering, custom Christmas light designs, siding, windows, doors, garage doors, and the like.

In some embodiments, additional data sets may be included within the roof report 200. For example, data sets may include, but are not limited to, weather data, insurance/valuation data, census data, school district data, real estate data, and the like.

Weather data sets may be provided by one or more databases storing information associated with weather (e.g., inclement weather). A weather data set within the roof report 200 may include, but is not limited to, hail history information and/or location, wind data, severe thunderstorm data, hurricane data, tornado data, and/or the like. In some embodiments, the one or more databases providing weather information may be hosted by a separate system (e.g., LiveHailMap.com) and provide information to the first host system 102 and/or the second host system 126. The weather data set may be included within the roof report 200 and provided to the customer and/or other parties. In some embodiments, weather data sets may be provided within a report as described herein without the addition of roof related information (e.g., roofing data set 204).

Insurance and/or valuation data sets may be provided by one or more databases storing information associated with housing insurance and/or valuation. An insurance and/or valuation data set may include, but is not limited to, insured value of the home, insurance premium amount, type of residence (e.g., multi-family, single family), number of floors (e.g., multi-floor, single-floor), building type, and/or the like. In some embodiments, the one or more databases may be hosted by a separate system (e.g., Bluebook, MSB, 360Value) and provide information to the first host system 102 and/or the second host system 126.

The insurance and/or valuation data set may be included within the roof report 200 and provided to the customer and/or other parties. For example, during underwriting of a home, an insurance company may be able to request the roof report 200 on a home that is recently purchased. The information within the roof report 200 may be integrated with insurance information provided by an insurance database and used to form a quote report. The quote report may be sent to the customer and/or insurance company. Alternatively, the roof report 200 may be solely sent to the insurance company with the insurance company using the information to formulate a quote.

In another example, the roof report 200 may be used in an insurance claim. In the case of a catastrophe of a customer, one or more databases may be used to provide an insurance dataset with claim information in the roof report 200. For example, an insurance database having a policy in force (PIF) and a weather database may be used to correlate information regarding an insurance claim for a particular roof. This information may be provided within the roof report 200.

Real estate and/or census data sets may also be including within the roof report. The real estate and/or census data sets may be provided by one or more databases having detailed information of a home. For example, a real estate data set may include, but is not limited to, the homeowner's name, the purchase price of the home, number of times the home has been on the market, the number of days the home has been on the market, the lot size, and/or the like. The census data set may include information concerning the number of residents within the home. In some embodiments, the one or more databases may be hosted by a separate system (e.g., Core Logic) and provide information to the first host system 102 and/or the second host system 126 to provide data sets as described herein. The real estate data set may be included within the roof report 200 and provided to the customer and/or other parties.

The roof reports 200 may include roofing data as described herein; however, system 100 may be used to provide other information to a customer and/or other party without roof related information (e.g., roofing data set 204). For example, in a real estate transaction, one or more databases in host system 102 and/or host system 126 may include recent home sales over time in one or more geographic areas. The footprint of each home and home valuation may be provided in one or more databases within host system 102 and/or host system 126. Using the systems and methods described herein, a customer (e.g., homeowner) may request a report determining approximate sales price of a home using the footprint and/or valuation versus comparables within the geographic area. The report may provide an approximate sale price of the home. In some embodiments, demographics of the homeowners may be used and stored in one or more databases. The demographic information may be used for potential advertising and/or comparables within the geographic area.

In another example, using systems and methods as described herein, a report may be provided for housecleaning and/or home services area (e.g., fireplace cleaning, pool sales, fencing, lawn maintenance/gardening, pavement resurfacing, decking, sunrooms, roofing, guttering, custom Christmas light designs, siding, windows, doors, garage doors, and the like). For example, using a footprint of a home, number of stories within a home, and the like, a determination of average square footage within a home may be determined. This information may be used to formulate a price quote for cleaning services.

Other services related to roofing may be provided within the roof report 200. For example, using the square footage of the roofing footprint, a price quote may be generated on the cost of insulation for the roof (e.g., energy efficiency, insulation replacement, and the like). Additionally, audits may be performed using information within one or more databases. For example, using the roofing area of a home, historically paid insurance claims for comparables, and validation of payment for a specific claim for the home, a comparison may be made to determine whether the service payment for the specific claim was within a certain threshold. Auditing, it should be understood, may be applied to other areas as described herein as well.

Although the terms “home” and “house” are used herein, it should be noted that the systems and methods in the present disclosure may be applied to any residential and/or commercial building or structure.

From the above description, it is clear that the inventive concept(s) disclosed herein is well adapted to carry out the objects and to attain the advantages mentioned herein as well as those inherent in the inventive concept(s) disclosed herein. While presently preferred embodiments of the inventive concept(s) disclosed herein have been described for purposed of this disclosure, it will be understood that numerous changes may be made which will readily suggest themselves to those skilled in the art and which are accomplished within the scope and spirit of the inventive concept(s) disclosed herein and defined by the appended claims.

What is claimed is:

1. One or more non-transitory computer readable medium storing a set of computer executable instructions for running on one or more computer systems that when executed cause the one or more computer systems to:
receive, through a graphical user interface, a request for a roof report from a user;
analyze pixels of at least two images of a roof having a plurality of roof portions, the at least two images taken from different perspectives, at least one of the images being an oblique image, to determine:
a footprint of the roof, comprising an outer boundary of the roof, utilizing two-dimensional or three-dimensional information regarding edges of the roof to determine line segments of the footprint; and
a predominant pitch of the roof;
determine an estimated roofing area of the roof based on the predominant pitch and the footprint of the roof; and
generate the roof report, wherein the roof report includes at least one image showing the roof and the estimated roofing area of the roof.

2. The one or more non-transitory computer readable medium storing a set of computer executable instructions for running on one or more computer systems of claim 1, that when executed further cause the one or more computer systems to receive a location of the roof and to obtain the at least two images of the roof based on the location of the roof.

3. The one or more non-transitory computer readable medium storing a set of computer executable instructions for running on one or more computer systems of claim 2, that when executed further cause the one or more computer systems to receive validation of the location of the roof.

4. The one or more non-transitory computer readable medium storing a set of computer executable instructions for running on one or more computer systems of claim 1, wherein the roof report includes one or more ortho images of the roof, one or more oblique images of the roof, the estimated roofing area, and contact information of one or more contractor within a region of interest of a geographic location of the roof.

5. The one or more non-transitory computer readable medium storing a set of computer executable instructions for running on one or more computer systems of claim 1, that when executed further cause the one or more computer systems to provide the roof report to one or more contractors, the contractor located within a region of interest of a geographic location of the roof.

6. The one or more non-transitory computer readable medium storing a set of computer executable instructions for running on one or more computer systems of claim 1, wherein the estimated roofing area of the roof is reported as a quantity of roofing material.

7. The one or more non-transitory computer readable medium storing a set of computer executable instructions for running on one or more computer systems of claim 1, wherein analyzing pixels of at least two images to determine the predominant pitch of the roof further comprises determining a first pitch factor and a second pitch factor, and wherein determining the predominant pitch comprises combining the first pitch factor and the second pitch factor.

8. The one or more non-transitory computer readable medium storing a set of computer executable instructions for running on one or more computer systems of claim 7, wherein combining the first pitch factor and the second pitch factor comprises determining a weighted average of the first pitch factor and the second pitch factor.

9. The one or more non-transitory computer readable medium storing a set of computer executable instructions for running on one or more computer systems of claim 8, wherein the first pitch factor is indicative of a pitch of a first portion of the plurality of roof portions, the second pitch factor is indicative of a pitch of a second portion of the plurality of roof portions, and wherein determining a weighted average of the first pitch factor and the second pitch factor is based on corresponding percentages of the roof of the first portion and the second portion of the roof having the first pitch factor and the second pitch factor.

10. The one or more non-transitory computer readable medium storing a set of computer executable instructions for running on one or more computer systems of claim 1, that when executed further cause the one or more computer systems to receive a roofing order for the roof report.

11. A roofing estimate method, comprising:
receiving, with at least one computer processor through a graphical user interface, a request for a roof report from a user;
analyzing, with the at least one computer processor, pixels of at least two images of a roof taken from different perspectives, the roof having a plurality of roof portions, the at least two images taken from different perspectives, at least one of the images being an oblique image;
determining, with the at least one computer processor, based on the analysis of the pixels:
a footprint of the roof, comprising a two-dimensional outer boundary of the roof, utilizing two-dimensional or three-dimensional information regarding edges of the roof to determine line segments of the footprint; and
a predominant pitch of the roof;
determining, with the at least one computer processor, an estimated roofing area of the roof based on the predominant pitch and the footprint of the roof; and
generating a roof report, wherein the roof report includes at least one image showing the roof and the estimated roofing area of the roof.

12. One or more non-transitory computer readable medium storing a set of computer executable instructions for running on one or more computer systems that when executed cause the one or more computer systems to:
receive, through a graphical user interface, a request for a roof report from a user;
analyze pixels of at least two images of a roof having a plurality of roof portions, the at least two images taken from different perspectives, at least one of the images being an oblique image, to determine:
a footprint of the roof, comprising an outer boundary of the roof, utilizing two-dimensional or three-dimensional information regarding edges of the roof to determine line segments of the footprint; and
a predominant pitch of the roof;
determine an estimated roofing area of the roof based on the predominant pitch and the footprint of the roof; and
generate a roof report including the estimated roofing area of the roof.

13. The one or more non-transitory computer readable medium storing a set of computer executable instructions for running on one or more computer systems of claim 12, that when executed further cause the one or more computer systems to receive a location of the roof and to obtain the at least two images of the roof based on the location of the roof.

14. The one or more non-transitory computer readable medium storing a set of computer executable instructions for running on one or more computer systems of claim 12, that when executed further cause the one or more computer systems to receive validation of the location of the roof.

15. The one or more non-transitory computer readable medium storing a set of computer executable instructions for running on one or more computer systems of claim 12, wherein the roof report includes one or more ortho images of the roof, one or more oblique images of the roof, the estimated roofing area, and contact information of one or more contractor within a region of interest of a geographic location of the roof.

16. The one or more non-transitory computer readable medium storing a set of computer executable instructions for running on one or more computer systems of claim 12, that when executed further cause the one or more computer systems to provide the roof report to one or more contractors, the contractor located within a region of interest of a geographic location of the roof.

17. The one or more non-transitory computer readable medium storing a set of computer executable instructions for running on one or more computer systems of claim 12, wherein the estimated roofing area of the roof is reported as a quantity of roofing material.

18. The one or more non-transitory computer readable medium storing a set of computer executable instructions for running on one or more computer systems of claim 12, wherein analyzing pixels of at least two images to determine the predominant pitch of the roof further comprises determining a first pitch factor and a second pitch factor, and wherein determining the predominant pitch comprises combining the first pitch factor and the second pitch factor.

19. The one or more non-transitory computer readable medium storing a set of computer executable instructions for running on one or more computer systems of claim 18, wherein combining the first pitch factor and the second pitch factor comprises determining a weighted average of the first pitch factor and the second pitch factor.

20. The one or more non-transitory computer readable medium storing a set of computer executable instructions for running on one or more computer systems of claim 19, wherein the first pitch factor is indicative of a pitch of a first portion of the plurality of roof portions, the second pitch factor is indicative of a pitch of a second portion of the plurality of roof portions, and wherein determining the weighted average of the first pitch factor and the second pitch factor is based on corresponding percentages of the roof of the first portion and the second portion of the roof having the first pitch factor and the second pitch factor.
